(19) United States
(12) Patent Application Publication
(10) Pub. No.: US 2020/0184847 A1
(43) Pub. Date: Jun. 11, 2020

(54) A SYSTEM AND METHOD FOR ON-PREMISE CYBER TRAINING

(71) Applicant: CYBERBIT LTD, Raanana (IL)

(72) Inventors: Shai GABAY, Raanana (IL); Oren ASPIR, Raanana (IL); Gali CARMEL, Raanana (IL)

(21) Appl. No.: 16/615,402

(22) PCT Filed: Nov. 28, 2017
(86) PCT No.: PCT/IL2017/051294

§ 371 Date: Nov. 21, 2019

(30) Foreign Application Priority Data
May 23, 2017 (IL) 252455

(51) Int. Cl. G09B 19/00; G06F 21/57

(52) U.S. Cl. CPC G09B 19/0053; G09B 7/00; G06F 2221/034; G06F 21/57

(57) ABSTRACT

A system comprising a log generator, the log generator comprising a processor, the processor configured to: generate, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and provide the fictitious log files to the OLMS, thereby causing the OLMS to analyze the fictitious log files, identify the evidence, and generate one or more alerts of the attacks.

### TECHNICAL FIELD

The invention relates to a system and method for on-premise cyber training

### BACKGROUND

Modern organizations are facing various growing threats of cyber-attacks on their organizational Information Technology (IT) systems (e.g. servers, databases, endpoints, networks, security systems, or any other system required for operating and/or protecting the organization's computing resources). Such cyber threats are constantly evolving and changing, becoming more and more sophisticated. In addition, new cyber threats are constantly created by cyber attackers.

Many organizations utilize various systems (including, for example, Security Information and Event Management systems, Security Incident Response Systems, etc.), for monitoring the organizations' IT systems, identifying cyber threats, and responding accordingly. In many cases, these activities are performed through a Security Operation Center (SOC) of the organization, where human security analysts use various systems for monitoring, analyzing and responding to cyber-attacks.

Currently, training of the security analysts is usually performed on a simulated training environment, that is separate from the operational IT environment, and in many cases also in a different location, dedicated for training

There are many disadvantages of training personnel in such off-premise setting, where the training is performed on a dedicated simulated environment, and not on the actual IT environment that the security analyst will need to handle in real-life situations.

There is thus a need in the art for a new system and method for on-premise cyber training

References considered to be relevant as background to the presently disclosed subject matter are listed below. Acknowledgement of the references herein is not to be inferred as meaning that these are in any way relevant to the patentability of the presently disclosed subject matter.

U.S. Pat. No. 9,558,677 (Sadeh-Koniecpol et al.) published on 31 Jan. 2017, discloses a training system senses a user action that may expose the user to a threat, such as a cybersecurity threat. The user action may be in response to a mock attack delivered via a messaging service, a wireless communication service, a fake malware application or another device, service, system or mechanism. The system selects a training action from a collection of available training actions and causes the training action to be delivered to the user.

U.S. Pat. No. 8,250,654 (Kennedy et al.) published on 21 Aug. 2012, discloses a process for facilitating a client system defense training exercise implemented over a client-server architecture includes designated modules and hardware for protocol version identification message; registration; profiling; health reporting; vulnerability status messaging; storage; access and scoring. More particularly, the server identifies a rule-based vulnerability profile to the client and scores client responses in accordance with established scoring rules for various defensive and offensive asset training scenarios.

Korean Patent No. 101460589 published on 12 Nov. 2014, discloses an exemplary version of the simulated train control system between according to the embodiment of the present invention is a virtual server to provide a version of the simulated training environment between the corresponding to the configuration of the trained network, the training person from operating the server connected to the virtual server, and the offensive and defensive team each to select, and the select training network training environment corresponding to the configuration of the trained network to be set to the virtual server, including the version simulated training control server among which the respective training person control to train on the virtual server. Accordingly, the present invention has the effect of reconfiguring the network environment physically and virtualization technology and by applying a hybrid method that combines the physical equipment by the network model the variable to control, and control the hacking attack and defense training

Japanese Patent No. 5905512 published on 20 Apr. 2016, discloses a problem to be solved: To prevent virtual environments of practicing persons from being influenced on each other and to safely perform practices when constructing the virtual environment for cyber-attack practices. Solution: A physical server 10 includes: a physical port 111 for exchanging management information with an instructor terminal 30; and a physical port 112 for a host group within the physical server 10 to communicate with an external network via an L3 switch 20. For each practicing terminal 40 that performs cyber-attack practices, the physical server 10 constructs a virtual network connecting host groups and hosts to be used for practices with each other. A port control section 124 is included by which, when any abnormality occurs in a practice environment, by making the physical port down on the basis of instruction input from the instructor terminal 30, such that influences on the external network are prevented. To the L3 switch 20 connected to the physical server 10, access control is set so as to prevent a host group from communicating with a host group of another practicing terminal 40.

### General Description

Throughout this specification, the following definitions are employed:

Operational IT Systems (OITSs): organizational IT systems used by organizational users for their daily activates and tasks and/or serving the organization business processes. These IT systems include IT systems that store organizational data whose integrity must be maintained and cannot be changed for training purposes. At least one of these IT systems has to maintain a certain level of availability which cannot be compromised for training purposes. An operational IT system is not purposely designed to be used for training purposes.

Attack training scenario: an attack training scenario defines a cyber-attack to be simulated on at least one of the OITSs. Some examples of cyber-attacks include a malware attack (e.g. a computer virus, ransomware, etc.), a phishing attack, an SQL injection attack, a denial-of-service attack, a web defacement attack, trojans and/or warms, data leakage, privilege escalation, and others. Each attack training scenario can comprise a plurality of stages, where each stage requires performing one or more actions, such as generating one or more fictitious log files and/or other evidence of the cyber-attack (e.g. executing one or more processes, making changes to one or more registry keys and/or values, or any performing any other action for generating information that is generated when the cyber-attack is performed). Stages can be performed simultaneously, or at different times.

Training exercise: a specific attack training scenario, or a group of two or more attack training scenarios, to be performed for training security analysts of the organization in dealing with cyber-attacks on the OITSs.

Security analyst: any person monitoring, and/or responding to, alerts of cyber-attacks on the organization raised by any organizational system that provides such alerts and/or enables responding thereto.

In accordance with a first aspect of the presently disclosed subject matter there is provided a system comprising a log generator, the log generator comprising a processor, the processor configured to: generate, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and provide the fictitious log files to the OLMS, thereby causing the OLMS to analyze the fictitious log files, identify the evidence, and generate one or more alerts of the attacks.

In some cases, the attack training scenarios are selected by an operator, from a list of pre-defined attack training scenarios.

In some cases, at least one given attack training scenario of the attack training scenarios comprises one or more stages, wherein the fictitious log files are generated for each of the stages.

In some cases, the given attack training scenario further defines an order of execution of the stages, and wherein the stages are performed based on the order of execution.

In some cases, the given attack training scenario further defines a timing of execution of the stages, and wherein the stages are performed based on the timing of execution.

In some cases, the processor is further configured to receive information identifying each OITS of the OITSs for which the fictitious log files are generated, the information including at least a type and a current version of the corresponding OITS, and wherein the fictitious log files are generated based on the received information.

In some cases, the information further includes a configuration of the corresponding OITS.

In some cases, the information is received from a scanner configured to automatically discover the OITSs and to automatically obtain the configuration of the corresponding OITS.

In some cases, the alerts are provided to one or more security analysts of the organization for training purposes.

In some cases, the generate and the provide are performed for at least two attack training scenarios.

In some cases, the generate and the provide are performed for the at least two attack training scenarios simultaneously.

In some cases, the generate includes generating at least two fictitious log files and wherein the provide includes providing the at least two fictitious log files to the OLMS simultaneously.

In some cases, the provide includes placing the fictitious log files in a first location monitored by the OLMS or in a second location accessible by a connector of the OLMS, the connector configured to collect and parse the fictitious log files of a given OITS of the OITSs.

In some cases, the OLMS is a Security Information and Events Management (SIEM) system of the organization.

In some cases, the system further comprises one or more TRaining IT Systems (TRITSs), wherein (a) each TRITS is a copy of a corresponding OITS of the OITSs, and (b) at least one of the TRITS comprises attack evidence indicative of the attack, thereby enabling the security analysts to investigate the attack evidence.

In some cases, the system further comprising an assessment system configured to calculate a grade for at least one of the security analysts, based on one or more actions performed on the TRITS by the security analyst and on expected actions defined by a Security Operation Center (SOC) manager of the organization.

In some cases, the assessment system is further configured to monitor respective timestamps of the actions made by each security analyst of the security analysts, and wherein the grade is further calculated based on the timestamps.

In some cases, the attack evidence are generated by performing the attack on the at least one of the TRITS.

In some cases, the TRITSs are installed on an isolated environment, isolated from the OITSs environment.

In some cases, the isolated environment is a virtual environment.

In some cases, the TRITS can be accessed by the security analysts through a one directional connection.

In some cases, the system further comprises a Security Incident Response System (SIRS), the SIRS configured to: receive the alerts from the OLMS; provide the alerts to the security analysts; provide, to the security analysts, one or more suggested actions in response to the alerts; receive at least one instruction, from the security analysts, based on the suggested actions; and preform the instruction on the OITS in a first mode of the SIRS, being a live mode, and not performing the instruction on the OITS in a second mode, being a training mode.

In some cases, the system further comprises an assessment system configured to calculate a grade for at least one of the security analysts, based on the at least instruction and on expected instructions provided by a Security Operation Center (SOC) manager of the organization.

In some cases, the system further comprises an assessment system configured to provide each security analyst of the security analysts with a list of one or more questions relating to responses of the security analyst to one or more attack of the attacks, and to receive answers to the questions from the security analyst.

In some cases, the assessment system is further configured to enable a Security Operation Center (SOC) manager of the organization to determine at least one question of the questions.

In some cases, the assessment system is further configured to provide a grade based at least on comparison of the answers and expected answers provided by a Security Operation Center (SOC) manager of the organization.

In some cases, the assessment system is further configured to monitor respective timestamps of actions made by each security analyst of the security analysts, and wherein the grade is further calculated based on the timestamps.

In accordance with a second aspect of the presently disclosed subject matter there is provided a method comprising: generating, by a processor, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and providing, by the processor, the fictitious log files to the OLMS, thereby causing the OLMS to analyze the fictitious log files, identify the evidence, and generate one or more alerts of the attacks.

In some cases, the attack training scenarios are selected by an operator, from a list of pre-defined attack training scenarios.

In some cases, at least one given attack training scenario of the attack training scenarios comprises one or more stages, wherein the fictitious log files are generated for each of the stages.

In some cases, the given attack training scenario further defines an order of execution of the stages, and wherein the stages are performed based on the order of execution.

In some cases, the given attack training scenario further defines a timing of execution of the stages, and wherein the stages are performed based on the timing of execution.

In some cases, the method further comprises receiving, by the processor, information identifying each OITS of the OITSs for which the fictitious log files are generated, the information including at least a type and a current version of the corresponding OITS, and wherein the fictitious log files are generated based on the received information.

In some cases, the information further includes a configuration of the corresponding OITS.

In some cases, the information is received from a scanner configured to automatically discover the OITSs and to automatically obtain the configuration of the corresponding OITS.

In some cases, the alerts are provided to one or more security analysts of the organization for training purposes.

In some cases, the generating and the providing are performed for at least two attack training scenarios.

In some cases, the generating and the providing are performed for the at least two attack training scenarios simultaneously.

In some cases, the generating includes generating at least two fictitious log files and wherein the providing includes providing the at least two fictitious log files to the OLMS simultaneously.

In some cases, the providing includes placing the fictitious log files in a first location monitored by the OLMS or in a second location accessible by a connector of the OLMS, the connector configured to collect and parse the fictitious log files of a given OITS of the OITSs.

In some cases, the OLMS is a Security Information and Events Management (SIEM) system of the organization.

In some cases, the method further comprises providing one or more TRaining IT Systems (TRITSs), wherein (a) each TRITS is a copy of a corresponding OITS of the OITSs, and (b) at least one of the TRITS comprises attack evidence indicative of the attack, thereby enabling the security analysts to investigate the attack evidence.

In some cases, the method further comprises providing an assessment system configured to calculate a grade for at least one of the security analysts, based on one or more actions performed on the TRITS by the security analyst and on expected actions defined by a Security Operation Center (SOC) manager of the organization.

In some cases, the assessment system is further configured to monitor respective timestamps of the actions made by each security analyst of the security analysts, and wherein the grade is further calculated based on the timestamps.

In some cases, the attack evidence are generated by performing the attack on the at least one of the TRITS.

In some cases, the TRITSs are installed on an isolated environment, isolated from the OITSs environment.

In some cases, the isolated environment is a virtual environment.

In some cases, the TRITS can be accessed by the security analysts through a one directional connection.

In some cases, the method further comprises providing a Security Incident Response System (SIRS), the SIRS configured to: receive the alerts from the OLMS; provide the alerts to the security analysts; provide, to the security analysts, one or more suggested actions in response to the alerts; receive at least one instruction, from the security analysts, based on the suggested actions; and preform the instruction on the OITS in a first mode of the SIRS, being a live mode, and not performing the instruction on the OITS in a second mode, being a training mode.

In some cases, the method further comprises providing an assessment system configured to calculate a grade for at least one of the security analysts, based on the at least instruction and on expected instructions provided by a Security Operation Center (SOC) manager of the organization.

In some cases, the method further comprises providing an assessment system configured to provide each security analyst of the security analysts with a list of one or more questions relating to responses of the security analyst to one or more attack of the attacks, and to receive answers to the questions from the security analyst.

In some cases, the assessment system is further configured to enable a Security Operation Center (SOC) manager of the organization to determine at least one question of the questions.

In some cases, the assessment system is further configured to provide a grade based at least on comparison of the answers and expected answers provided by a Security Operation Center (SOC) manager of the organization.

In some cases, the assessment system is further configured to monitor respective timestamps of actions made by each security analyst of the security analysts, and wherein the grade is further calculated based on the timestamps.

In accordance with a third aspect of the presently disclosed subject matter there is provided a non-transitory computer readable storage medium having computer readable program code embodied therewith, the computer readable program code, executable by at least one processor of a computer to perform a method comprising: generating, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and providing the fictitious log files to the OLMS, thereby causing the OLMS to analyze the fictitious log files, identify the evidence, and generate one or more alerts of the attacks.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for on-premise cyber training, in accordance with the presently disclosed subject matter;

FIG. 2 is a block diagram schematically illustrating one example of a log generator, in accordance with the presently disclosed subject matter;

FIG. 3 is a block diagram schematically illustrating one example of a Security Incident Response System (SIRS), in accordance with the presently disclosed subject matter;

FIG. 4 is a block diagram schematically illustrating one example of an assessment system, in accordance with the presently disclosed subject matter;

FIG. 5 is a flowchart illustrating one example of a sequence of operations carried out for generating fictitious log files, in accordance with the presently disclosed subject matter;

FIG. 6 is a flowchart illustrating one example of an operations carried out for obtaining information identifying operational IT systems of an organization, in accordance with the presently disclosed subject matter;

FIG. 7 is a flowchart illustrating one example of a sequence of operations carried out by a SIRS for enabling training in a training mode of the SIRS, in accordance with the presently disclosed subject matter; and

FIG. 8 is a flowchart illustrating one example of a sequence of operations carried out for grading a security analyst training exercise, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “generating”, “providing”, “receiving”, “placing”, “performing”, “calculating”, “monitoring” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter.

Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

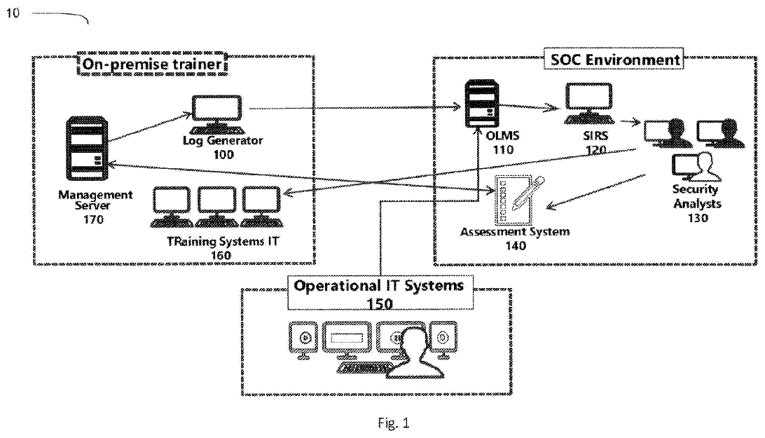

In embodiments of the presently disclosed subject matter, fewer, more and/or different stages than those shown in FIGS. 5-8 may be executed. In embodiments of the presently disclosed subject matter one or more stages illustrated in FIGS. 5-8 may be executed in a different order and/or one or more groups of stages may be executed simultaneously. FIGS. 1-4 illustrate a general schematic of the system architecture in accordance with an embodiment of the presently disclosed subject matter. Each module in FIGS. 1-4 can be made up of any combination of software, hardware and/or firmware that performs the functions as defined and explained herein. The modules in FIGS. 1-4 may be centralized in one location or dispersed over more than one location. In other embodiments of the presently disclosed subject matter, the system may comprise fewer, more, and/or different modules than those shown in FIGS. 1-4.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, showing a block diagram schematically illustrating one example of a system for on-premise cyber training, in accordance with the presently disclosed subject matter.

An organizational environment 10 includes various operational IT systems (OITSs) 150. As indicated above, such OITSs 150 are under constant threat of cyber-attacks.

One system that is utilized for monitoring the OITSs 150 is an Operational Log Monitoring System (OLMS) 110. The OLMS 110 is configured to monitor a plurality of log files generated by the OITSs 150, and to analyze such log files in order to identify evidence of a potential cyber-attack. In some cases, the OLMS 110 further monitors other parts of the environment 10, or specific components thereof, for identifying evidence of a potential cyber-attack other than the log files (e.g. specific processes or processes having certain attributes, changes to one or more registry keys/values of one or more of the OITSs 150, etc.). Upon identification of potential cyber-attack evidence, the OLMS 110 can provide an alert to one or more security analysts 130 (e.g. by displaying a notification on a workstation, or any other device, operated by the security analyst 130). In some cases, the OLMS 110 can be a Security Information and Event Management system (SIEM), such as any SIEM known in the art.

Additionally, or alternatively, the OLMS 110 can provide the alerts to a Security Incident Response Systems (SIRS) 120. The SIRS 120 can provide the alerts to the security analysts 130 (e.g. by displaying a notification on a workstation, or any other device, operated by the security analyst 130), optionally with one or more suggested actions to be performed in response to the identified potential cyber-attack. In some cases, based on the suggested responses, the SIRS 120 can be configured to receive one or more instructions, for one or more actions to be performed on one or more of the OITSs, from the security analysts 130 and perform the instruction. The actions can include 150, for example, rebooting an OITS, restoring an OITS from backup, switching to a backup OITS, closing one or more ports on a firewall (being an OITS of the OITSs 150), installing one or more patches on one or more OITS, etc.

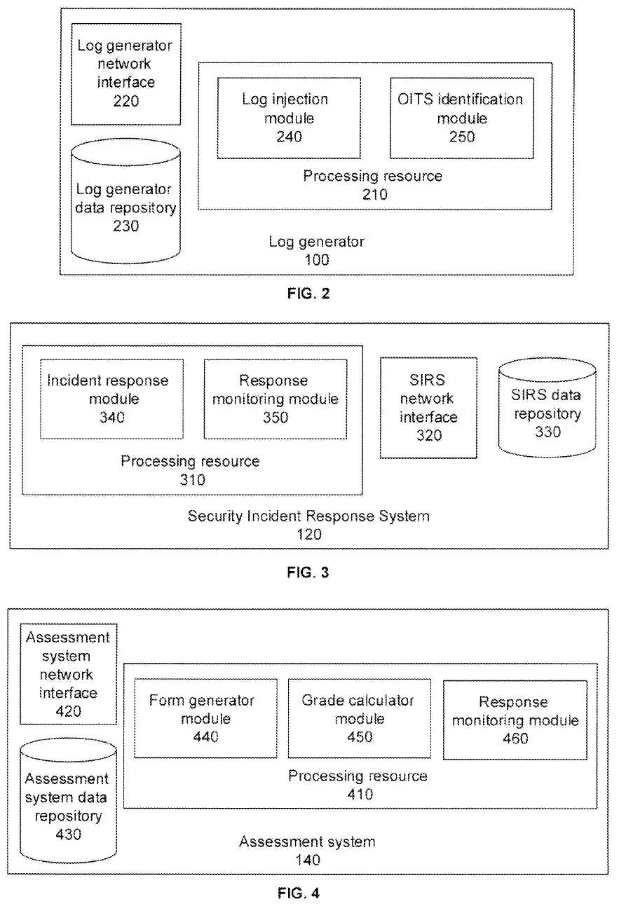

According to some examples of the presently disclosed subject matter, the organizational environment 10 includes a log generator 100. The log generator 100 is configured to generate fictitious log files, identifiable by the OLMS 110 as log files of one or more OITSs 150, each fictitious log file comprising one or more log entries identifiable by the OLMS 110 as evidence of an attack, on at least one OITS of the OITSs 150. Such log files can be provided to the OLMS 110, thereby causing the OLMS 110 to analyze the fictitious log files, identify the attack evidence, and generate one or more alerts of the attacks. In some cases, the log generator 100 can be further configured to generate other evidence of the attack, other than the log files (e.g. execute specific processes or processes having certain attributes, change one or more registry keys/values of one or more of the OITSs 150, etc.). A further explanation about the operation of the log generator 100 and the OLMS 110 is provided herein, inter alia with reference to FIGS. 2 and 5.

It is to be noted, that utilization of fictitious log files, and/or other evidence of a cyber-attack generated by the log generator 100, enables performing training exercises, comprising one or more attack training scenarios, for training the security analysts 130 on-premise, using the organization's operational tools (including the OLMS 110), without compromising the OITSs 150—as there is no need of performing any manipulation thereon. While the OITSs 150 are uncompromised, use of the fictitious log files, and/or other evidence of a cyber-attack generated by the log generator 100, enables using the OLMS 110, used for monitoring the actual logs of the OITSs 150, for training purposes.

As indicated herein, in some cases, the OLMS 110 can provide alerts on potential cyber-attacks to a SIRS 120. According to the presently disclosed subject matter, the SIRS 120 (if present) can optionally have a dual operation mode. In such cases, the operation modes can be a “live” mode, and a “training” mode. In a “live” mode, the SIRS 120 can perform any action instructed by the security analysts 130 on the OITS 150, whereas in a “training” mode, the SIRS 120 can avoid performing the actions instructed by the security analysts 130 (thereby not affecting the OITSs 150).

In some cases, the environment 10 can further comprise one or more Training IT Systems (TRITS) 160. The TRITS 160 can be copies of one or more corresponding OITSs 150 running in a real or virtual environment. The TRITS 160 can be installed, and operate, on an isolated environment, isolated from the OITSs 150 environment, so that the TRITS 160 have no access to the OITSs 150 and vice versa. In such cases, the security analysts 130 can have access to the TRITS 160 via a single-sided connection (e.g. a one-way remote desktop connection session, enabling the security analyst 130 to view the screen of one or more of the TRITS 160, and to control the Input/output (IO) devices of one or more of the TRITS 160). In other cases, the TRITS 160 can be installed on the same environment of the OITSs 150, and optionally also at least partially on the same hardware (e.g. servers).

The TRITS 160 can be utilized for enabling a security analyst 130 to investigate certain aspects of a simulated cyber-attack, and/or evidence thereof, on an environment that is optionally other than the OITSs 150 environment. This enables the security analyst 130 to perform various actions that affect one or more of the TRITS 160, without affecting the OITSs 150. For this purpose, one or more attack simulations can be executed on one or more of the TRITS 160 for enabling a security analyst 130 to train on an attacked environment simulation, that is optionally separate from the OITSs 150. Alternatively, or additionally, one or more of the TRITS 160 can be configured to contain evidence of the cyber-attack. This can enable training the security analyst 130 on analysis of cyber-attacks and/or on responding to such cyber-attacks, without jeopardizing the OITSs 150 (especially when the TRITS are installed on an isolated environment, isolated from the OITSs 150 environment).

The TRITS 160 can also be used by the SIRS 120 when in “training” mode. In such cases, the SIRS 120 can be configured to perform any action instructed by the security analysts 130 on one or more corresponding TRITS 160 (to which the actions relate). This enables a more realistic training, in which the outcomes of the actions taken by the security analysts 130 can be assessed, without jeopardizing the OITSs 150 (especially when the TRITS are installed on an isolated environment, isolated from the OITSs 150 environment).

According to some examples of the presently disclosed subject matter, system's environment 10 can further comprise an assessment system 140. The assessment system 140 can enable assessing actions performed by the security analysts 130, and providing the security analysts 130 with feedback, such as a grade, on their actions during the training

In some cases, the assessment system 140 can provide the feedback based on analysis of a form comprising questions to be answered by the security analyst 130, during, or after finalizing, a training exercise. In some cases, the questions can be defined by an authorized user authorized to determine the questions (e.g. a SOC manager of the organization). The assessment system 140 can compare the answers provided by the security analyst 130 with expected answers. The expected answers can be provided by a user authorized to determine such expected answers (e.g. a SOC manager of the organization). It is to be noted that various organizations may have different procedures for handling a potential cyber-attack, and therefore, users from different organizations can define different questions and/or different expected answers (optionally to the same questions) to the questions provided to the security analyst.

Additionally, or alternatively, the assessment system 140 can be configured to obtain information of actions performed by the security analyst 130 on the SIRS 120 and/or on one or more of the TRITS 160, and the grade can be calculated based on comparison of the actions with expected actions provided by a user authorized to determine such expected actions for the organization (e.g. a SOC manager of the organization).

Furthermore, additionally, or alternatively, the assessment system 140 can be configured to obtain timestamps of the actions performed by the security analyst 130 on the SIRS 120 and/or on one or more of the TRITS 160, and the grade can be calculated based on the timestamps. For example, the grade can be calculated utilizing the timestamps so that the faster the security analyst 130 performed the expected actions—the higher the grade is (optionally assuming that the action is the expected action). Another example is that the security analyst 130 can be required to perform the action within a certain time (e.g. within five seconds, within thirty seconds, within one minute, within five minutes, within half an hour, etc.) in order to get a score associated with the specific expected action (assuming that a given expected action needs to be completed within ten seconds, the security analyst 130 can receive a score associated with this action if he performs the given expected action within ten seconds), and the timestamp can be used to determine if the security analyst 130 performed the given expected action on time.

In some cases, the assessment system 140 can be configured to provide ongoing, and optionally real-time, feedback (e.g. grades, hints, indication of correctness of actions performed by the security analysts 130, etc.) to the security analysts 130, based on actions performed thereby, and expected actions that the security analysts 130 are expected to perform (e.g. as defined by a user authorized to determine such expected actions for the organization, such as a SOC manager of the organization).

In some cases, the environment 10 can further comprise a management server 170. The management server 170 can be configured to enable a user authorized to control training of the security analysts 130 of the organization (e.g. a SOC manager of the organization) to execute a training exercise, comprised of one or more attack training scenarios, for training the security analysts 130. Upon selection of attack training scenario/s, the management server 170 can instruct the log generator 100 to generate the fictitious log files, etc., as detailed above, thereby starting the training exercise. In some cases, the management server 170 can be further configured to set-up the TRITS 160 to at least contain the attack evidence for the attack training scenarios of the training exercise.

In some cases, management server 170 can enable a user authorized to control training of the security analysts 130 of the organization (e.g. a SOC manager of the organization) to monitor progress of the security analysts 130 during the training exercise. In some cases, the management server 170 can be further configured to enable such user to provide one or more selected security analysts 130, or all security analysts 130, with instructions and/or feedback (e.g. hints, text messages, voice messages, etc.), optionally during the training exercise.

The management server 170 (in addition, or alternatively, to the assessment system 140) can be further configured to enable a user authorized to control training of the security analysts 130 of the organization (e.g. a SOC manager of the organization) to provide the questions and/or the expected answers and/or the expected actions utilized by the assessment system 140 as detailed above, e.g. through a user interface thereof.

It is to be noted that management server 170, log generator 100 and assessment system 140, or any combination thereof, can be software executing on shared hardware (e.g. on a single real/virtual server or a group of servers).

Attention is drawn to FIG. 2, showing a block diagram schematically illustrating one example of a log generator, in accordance with the presently disclosed subject matter.

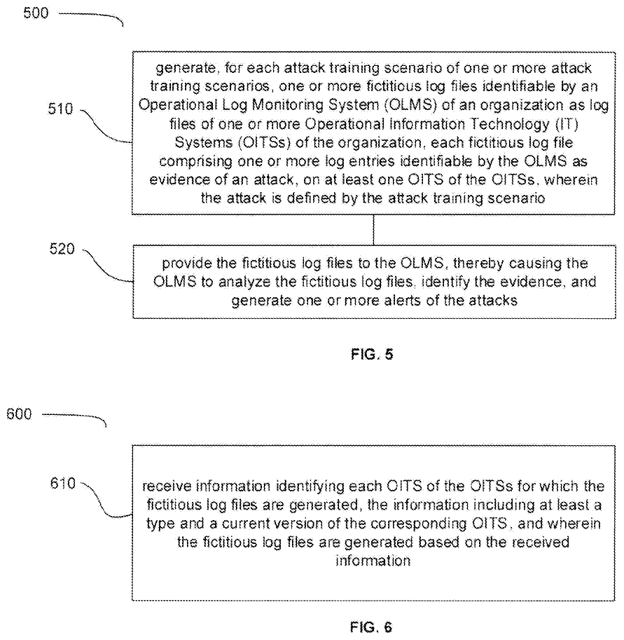

According to certain examples of the presently disclosed subject matter, log generator 100 can comprise a log generator network interface 220 (e.g. a network card, a WiFi client, a LiFi client, 3G/4G client, or any other component that enables the log generator 100 to connect to the OLMS 110 and/or to an organizational communication network to which the OITSs 150 are connected, etc.), enabling connecting the log generator 100 to the OLMS 110 and/or to an organizational communication network to which the OITSs 150 are connected (e.g. an organizational TCP/IP communication network) and enabling it to send data and/or receive data sent thereto, including sending fictitious log files to the OLMS 110 and/or to one or more locations on the organizational communication network, from which such fictitious log files are read and analyzed by the OLMS 110, as detailed herein, inter alia with reference to FIGS. 5 and 6.

Log generator 100 can further comprise, or be otherwise associated with, a log generator data repository 230 (e.g. a database, a storage system, a memory including Read Only Memory—ROM, Random Access Memory—RAM, or any other type of memory, etc.) configured to store data, including, inter alia, information of the types, versions and optionally the configurations of the OITSs 150 for which the log generator 100 can generate fictitious log files. Such information is utilized by the log generator 100 in order to generate fictitious log files that are formatted as if each of them was generated by a corresponding OITS 150.

Log generator 100 further comprises a processing resource 210. Processing resource 210 can be one or more processing units (e.g. central processing units), microprocessors, microcontrollers (e.g. microcontroller units (MCUs)) or any other computing processing device, which are adapted to independently or cooperatively process data for controlling relevant log generator 100 resources and for enabling operations related to log generator 100 resources.

The processing resource 210 can comprise one or more of the following modules: log injection module 240 and OITS identification module 250.

According to some examples of the presently disclosed subject matter, OITS identification module 250 can be configured to receive (optionally through an automatic process), information of the type (e g make and model) and/or version and/or configuration of one or more of the OITSs 150, as further detailed herein, inter alia with reference to FIG. 6. In some cases, such information can be provided manually (e.g. by a user authorized to provide such information, that can operate a user interface of the management system 170 for this purpose). In other cases, the OITS identification module 250 can receive such information (the type and/or version and/or configuration of one or more of the OITSs 150) from a scanner (e.g. an agent) scanning the organizational communication network to detect new OITSs 150, or updates to existing OITSs 150 (e.g. new versions, updated configurations, etc.).

Such information can be utilized by the log generator 100 in order to generate fictitious log files that are formatted as if each of them was generated by a corresponding OITS 150 (as in some cases, the type and/or version and/or configuration of the OITSs 150 can have an effect on the format of the log files generated thereby).

log injection module 240 can be configured to generate fictitious log files, identifiable by the OLMS 110 as log files of one or more OITSs 150, each fictitious log file comprising one or more log entries identifiable by the OLMS 110 as evidence of an attack, on at least one OITS of the OITSs 150. log injection module 240 can be further configured to provide the generated log files to the OLMS 110, thereby causing the OLMS 110 to analyze the fictitious log files, identify the attack evidence, and generate one or more alerts of the attacks. A further explanation about the operation of the log injection module 240 is provided herein, inter alia with reference to FIG. 5. It is to be noted that in some cases, the log generator 100 can generate additional log files (including log files that are not provided to the OLMS 110), and/or additional evidence of the attack, other than log files (e.g. specific processes or processes having certain attributes, changes to one or more registry keys/values of one or more of the OITSs 150, etc.). Such additional log files and/or additional evidence can be placed/employed on one or more of the OITSs 150 and used by the security analysts 130 when investigating the attack.

Turning to FIG. 3, there is shown a block diagram schematically illustrating one example of a Security Incident Response System (SIRS), in accordance with the presently disclosed subject matter.

According to certain examples of the presently disclosed subject matter, Security Incident Response System (SIRS) 120 can comprise a SIRS network interface 320 (e.g.

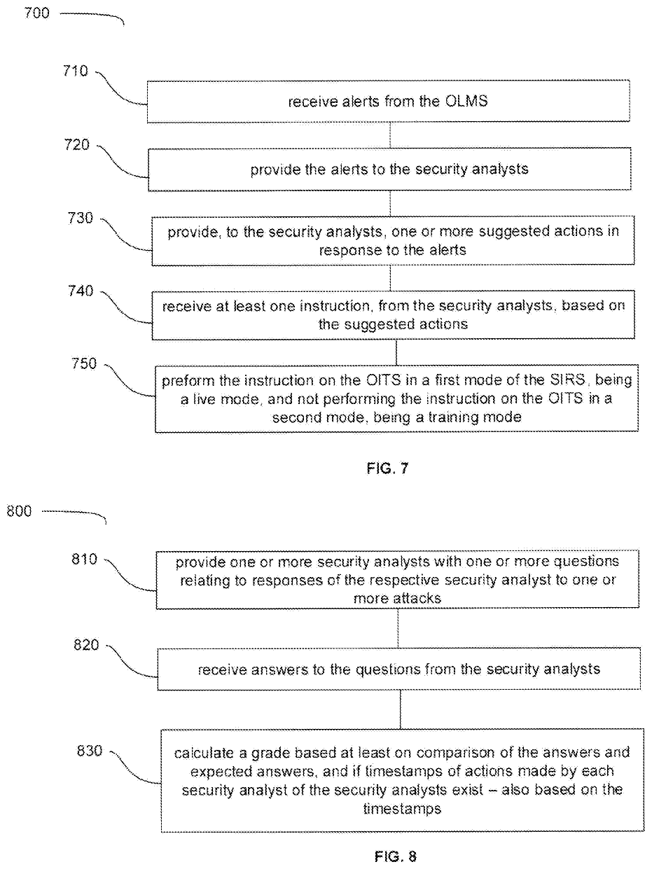

a network card, a WiFi client, a LiFi client, 3G/4G client, or any other component that enables the SIRS 120 to connect to an organizational communication network to which the OLMS 110 is connected, etc.), enabling connecting the SIRS 120 to an organizational communication network to which the OLMS 110 is connected (e.g. an organizational TCP/IP communication network) and enabling it to send data and/or receive data sent thereto, through the organizational communication network, including receiving alerts generated by the OLMS 110 and providing suggested responses to workstations of the security analysts 130, as detailed herein, inter alia with reference to FIG. 7.

SIRS 120 can further comprise, or be otherwise associated with, a SIRS data repository 330 (e.g. a database, a storage system, a memory including Read Only Memory—ROM, Random Access Memory—RAM, or any other type of memory, etc.) configured to store data, including, inter alia, suggested responses corresponding to various alerts raised by the OLMS 110, and information relating to actual responses of the security analysts 130 to the alerts. It is to be noted that the SIRS data repository 330 and the log generator data repository 230 can be a single data repository (e.g. a single database, a single storage system), which can optionally be distributed.

SIRS 120 further comprises a processing resource 310. Processing resource 310 can be one or more processing units (e.g. central processing units), microprocessors, microcontrollers (e.g. microcontroller units (MCUs)) or any other computing processing device, which are adapted to independently or cooperatively process data for controlling relevant SIRS 120 resources and for enabling operations related to SIRS 120 resources.

The processing resource 310 can comprise one or more of the following modules: incident response module 240 and response monitoring module 250.

According to some examples of the presently disclosed subject matter, incident response module 240 can be configured to receive alerts from the OLMS 110 (the alerts can be alerts triggered by injection of one or more fictitious log files by the log generator 100), provide the alerts to the security analysts 130 (e.g. on a user interface of a workstation of the security analysts 130), and provide the security analysts with one or more suggested actions in response to the alerts, as further detailed herein, inter alia with reference to FIG. 7. In some cases, the incident response module 240 can be further configured to receive instructions from the security analysts 130, and act accordingly (e.g. by performing the instruction on one or more of the OITSs 150), as further detailed herein, inter alia with reference to FIG. 7.

Response monitoring module 250 can be configured to monitor the actual responses of the security analysts 130 to the alerts, and collect information relating thereto. The information can include which actions were performed by the security analyst 130, which instructions were received from the security analysts 130, a timestamp of each action/instruction provided by each security analysts 130 that provided one or more actions/instructions, etc. Such information can be used for evaluating the security analysts 130 performance during a training exercise, or during a real cyber-attack, and for grading such performance, as further detailed herein, inter alia with reference to FIG. 8.

FIG. 4 is a block diagram schematically illustrating one example of an assessment system, in accordance with the presently disclosed subject matter.

According to certain examples of the presently disclosed subject matter, assessment system 140 can comprise an assessment system network interface 420 (e.g. a network card, a WiFi client, a LiFi client, 3G/4G client, or any other component that enables the SIRS 120 to connect to an organizational communication network to which the workstations of the security analysts 130 and/or the SIRS 120 and/or the management server 170 are connected, etc.), enabling connecting the assessment system 140 to an organizational communication network to which the workstations of the security analysts 130 and/or the SIRS 120 and/or the management server 170 are connected (e.g. an organizational TCP/IP communication network) and enabling it to send data and/or receive data sent thereto, through the organizational communication network, including sending one or more questions relating to responses of the security analysts 130 to real or simulated cyber-attacks, receiving answers to such questions, receiving information relating to actions performed by the security analysts 130, and timestamps thereof, etc., as detailed herein, inter alia with reference to FIG. 8.

Assessment system 140 can further comprise an assessment system data repository 430 (e.g. a database, a storage system, a memory including Read Only Memory—ROM, Random Access Memory—RAM, or any other type of memory, etc.) configured to store data, including, inter alia, expected answers to questions provided to the security analysts 130, expected instructions the security analysts 130 are expected to provide in response to alerts, past grades calculated for security analysts during past training exercises (based on which the assessment system 140 can provide various statistical information to users, such as improvement graphs, etc.), etc. It is to be noted that the assessment system data repository 430 and one or more of the SIRS data repository 330 and the log generator data repository 230 can be a single data repository (e.g. a single database, a single storage system), which can optionally be distributed.

Assessment system 140 further comprises a processing resource 410. Processing resource 410 can be one or more processing units (e.g. central processing units), microprocessors, microcontrollers (e.g. microcontroller units (MCUs)) or any other computing processing device, which are adapted to independently or cooperatively process data for controlling relevant assessment system 140 resources and for enabling operations related to assessment system 140 resources.

The processing resource 410 can comprise one or more of the following modules: form designer module 440, grade calculator module 450 and response monitoring module 460.

According to some examples of the presently disclosed subject matter, form designer module 440 can be configured to generate a form comprising one or more questions to be answered by the security analysts 130, during, or after finalizing, a training exercise, as further detailed herein, inter alia with reference to FIG. 8. In some cases, at least one question can relate to one or more responses of the security analysts 130 to the alerts raised by the OLMS 110 and/or the SIRS 120.

Grade calculator module 450 can be configured to calculate a grade for the security analysts 130, based on various information relating to the security analysts' 130 performance during a training exercise, or optionally during a real cyber-attack. A further explanation about the grading process is provided herein, inter alia with reference to FIG. 8.

Response monitoring module 460 can be configured to monitor actions, and optionally timestamps thereof, made by the security analysts 130 on the security analysts' 130 workstations and/or on the SIRS 120 and/or on one or more of the TRITS 160, and the information gathered by the response monitoring module 460 can be used by the grade calculator module 450 for calculating the grade.

In some cases, the assessment system 140 can be configured to provide ongoing, and optionally real-time, feedback (e.g. grades, hints, indication of correctness of actions performed by the security analysts 130, etc.) to the security analysts 130, based on actions performed thereby, and on expected actions that the security analysts 130 are expected to perform (e.g. as defined by a user authorized to determine such expected actions for the organization, such as a SOC manager of the organization). In such cases, the response monitoring module 460 can be configured to provide such ongoing feedback.

Attention is drawn to FIG. 5, showing a flowchart illustrating one example of a sequence of operations carried out for generating fictitious log files, in accordance with the presently disclosed subject matter.

According to some examples of the presently disclosed subject matter, log generator 100 can be configure to perform a fictitious log injection process 500, e.g. utilizing the log injection module 240.

During the fictitious log injection process 500, the log generator 100 can be configured to generate one or more fictitious log files identifiable by the OLMS 110 as log files of one or more of the OITSs 150, each fictitious log file comprising one or more log entries identifiable by the OLMS as evidence of a cyber-attack, on at least one OITS of the OITSs 150 (block 510). It is to be noted that in some cases, the log generator 100 can generate additional log files (including log files that are not provided to the OLMS 110), and/or additional evidence of the attack, other than log files (e.g. specific processes or processes having certain attributes, changes to one or more registry keys/values of one or more of the OITSs 150, etc.). Such additional log files and/or additional evidence can be placed/employed on one or more of the OITSs 150 and used by the security analysts 130 when investigating the attack.

It is to be noted that block 510 can be performed for each training scenario of one or more attack training scenarios, where each attack training scenario defines a corresponding cyber-attack, on at least one of the OITSs 150, to be simulated. In some cases, the attack training scenarios can be defined (e.g. utilizing the management server 170), by a user authorized to control training of the security analysts 130 of the organization (e.g. a SOC manager of the organization), as a training exercise for training the security analysts 130. The training exercise can comprise a plurality of attack training scenarios (such as one or more malware attacks (e.g. virus, ransomware, etc.), one or more phishing attacks, one or more SQL injection attacks, one or more denial-of-service attack, one or more web defacement attack, one or more trojans and/or warms, data leakage, privilege escalation, any other type of cyber-attack having a footprint in log files monitored by the OLMS 110, or any other type of cyber-attack) selected by the user from a list of pre-defined attack training scenarios.

The log generator is further configured to provide the fictitious log files generated at block 510 to the OLMS 110, thereby causing the OLMS 110 to analyze the fictitious log files (which optionally includes parsing thereof), identify the evidence of the cyber-attack, and generate one or more alerts of the cyber-attack (or plurality of attacks in case more than one attack training scenario is provided) (block 520). Providing the fictitious log files to the OLMS 110 can include placing the fictitious log files in a first location monitored by the OLMS 110 or in a second location accessible by a connector (a software component executable on a computer having access to the second location) of the OLMS 110, the connector being a part of the OLMS 110 configured to collect the fictitious log files of a given OITS of the OITSs 150 from the second location, and parse them. Additionally, or alternatively, providing the log files can include injecting, to the OLMS 110 directly, parsed log files, generated as if such they have been parsed by the connectors.

In some cases, the alerts generated by the OLMS 110 can be provided to the security analysts 130 directly (e.g. via a user interface of the OLMS 110 available on a workstation of the security analysts 130). In additional, or alternative, cases, the alerts can be provided to the SIRS 120 (e.g. in cases where a SIRS 120 is provided, as further detailed herein with reference to FIG. 7), that in turn can provide the alerts, or a processed version thereof, to the security analysts (e.g. via a user interface of the SIRS 120 available on a workstation of the security analysts 130).

It is to be further noted that in some cases, at least one of the attack training scenarios of block 510 can comprise a plurality of stages, optionally having a corresponding order of execution (e.g. a first stage to be performed in parallel to or before a second stage, the second stage to be performed in parallel to or before a third stage, etc.), and optionally further having a corresponding timing of execution (e.g. the first stage to be executed when the training exercise begins, the second stage to be performed simultaneously with the first stage, or a certain time period thereafter, the third stage to be performed simultaneously with the second stage, or a certain time period after the second stage, etc.). In such cases, each stage can require generation of corresponding one or more fictitious log files of the log files generated at block 510, optionally at the corresponding timing of execution of the corresponding stage, and providing the generated log files to the OLMS 110. In some cases, one or more of the stages can require generating other/additional evidence of the attack (e.g. executing one or more processes, making changes to one or more registry keys and/or values, or any performing any other action for generating information that is generated when the cyber-attack is performed).

In a more detailed example, a given attack training scenario can include two or more stages. The first stage can require generating one or more first fictitious log files by the log generator 100 and providing the generated log files to the OLMS 110. The second stage can require generating one or more second fictitious log files by the log generator 100, simultaneously with generating the one or more first log files, or a certain time period afterwards (e.g. 5 seconds afterwards, 1 minute afterwards, etc.), and providing the generated log files to the OLMS 110. If more than two stages exist, for any subsequent stage the log generator can be configured to generate respective fictitious log files, at respective timing (as defined by the user), and to provide the generated log files to the OLMS 110. It is to be noted that in some cases, one or more of the stages can require generating other/additional evidence of the attack (e.g. executing one or more processes, making changes to one or more registry keys and/or values, or any performing any other action for generating information that is generated when the cyber-attack is performed).

It is to be still further noted that in some cases, blocks 510 and 520 are performed for at least two attack training scenarios during a single training exercise. In some cases, block 510 includes generating at least two fictitious log files (and optionally additional evidence of the attack as detailed herein) and block 520 includes providing the at least two fictitious log files to the OLMS 110 simultaneously.

As indicated herein, the fictitious log files have to be generated in a format identifiable by the OLMS 110 as a format of log files generated by the OITS 150 for which the fictitious log file are generated. In some cases, the format of a log file can depend on a type (e g make and model) and/or version and/or configuration of the OITS 150 generating such log file. In some cases, an OITS 150 of a first type and/or a first version and/or a first configuration can generate a log file in a first format, whereas an OITS 150 of a second type and/or version and/or configuration can generate a log file in a second format, different than the first format. Therefore, the log generator 100 requires information of at least a type (e g make and model) and a version of each OITS 150 for which it is required to generate a fictitious log file, and information of the format of the log files generated by each such OITS 150. Based on this information the log generator 100 can generate the fictitious log files, that are identifiable by the OLMS 110 as log files of the corresponding OITS 150.

It is to be noted that, with reference to FIG. 5, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Attention is drawn in this respect to FIG. 6, showing a flowchart illustrating one example of an operations carried out for obtaining information identifying operational IT systems of an organization, in accordance with the presently disclosed subject matter.

According to some examples of the presently disclosed subject matter, log generator 100 can be configure to perform an OITS identification process 600, e.g. utilizing the OITS identification module 240.

For this purpose, the log generator 100 can be configured to receive information identifying each OITS of the OITSs 150 for which the fictitious log files are to be generated (block 610). The information can include a type (e g make and model) of the corresponding OITS 150, based on which the fictitious log files are generated (as different types of OITSs 150 generate log files in different formats).

In some cases, the format of a log file generated by a given OITS of the OITSs 150 further depends on the version and/or configuration of the given OITS (e.g. in those cases where different versions of the OITS 150 generate log files in different formats, or in cases where the corresponding OITS 150 is configurable, and the configuration can have an effect on the format of the log file generated by the corresponding OITS 150). In such cases, the information further includes the version and/or the configuration of the corresponding OITS 150, and based on such information the log generator 100 can generate the fictitious log file, so that it will appear as if it was generated by the corresponding OITS 150 itself.

In some cases, the information of the types and/or versions and/or configurations of the OITSs 150 can be provided by a user (e.g. a SOC manager of the organization), optionally through a user interface of the management server 170. In other cases, the information of the types and/or versions and/or configurations of the OITSs 150 can be received from a scanner configured to automatically discover the OITSs 150 and to automatically obtain the information of the type and/or version and/or configuration of the OITSs 150. The scanner can be an agent installed on the OITSs 150 or on another location within the organizational communication network from which it can access such information of the OITSs 150 type and/or version and/or configuration. The scanner can scan the organizational communication network to detect new OITSs 150, or updates to existing OITSs 150 (e.g. new versions, updated configurations, etc.).

It is to be noted that, with reference to FIG. 6, that block 610 can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 7, there is shown a flowchart illustrating one example of a sequence of operations carried out by a SIRS for enabling training in a training mode of the SIRS, in accordance with the presently disclosed subject matter.

As indicated herein, when the organization operating the OLMS 110 also operates a SIRS 120, the OLMS 110 can provide alerts on potential cyber-attacks to the SIRS 120. According to some examples of the presently disclosed subject matter, SIRS 120 can be configure to perform an incident response process 700, e.g. utilizing the incidence response module 340.

For this purpose, the SIRS 120 can be configured to receive alerts generated by the OLMS 110 (the alerts can be alerts triggered by injection of one or more fictitious log files by the log generator 100 as detailed herein with reference to FIG. 5) (block 710), and to provide the received alerts, or a processed version thereof, to the security analysts 130 (block 720). In some cases, the alerts (or the processed version thereof), can be provided to the security analysts 130 via a user interface of a workstation operated thereby.

In addition, the SIRS 120 is further configured to provide the security analysts 130 with one or more suggested actions in response to the alerts (block 730). In some cases, the SIRS 120 can be further configured to receive instructions from the security analysts 130, optionally based on the suggested actions suggested at block 730 (block 740). The suggested actions (suggested by the SIRS 120) and/or the instructions (received from the security analyst 130) can include, for example, rebooting an OITS, restoring an OITS from backup, switching to a backup OITS, closing one or more ports on a firewall (being an OITS of the OITSs 150), installing one or more patches on one or more OITS, etc.

According to the presently disclosed subject matter, the SIRS 120 can optionally have a dual operation mode. In such cases, the operation modes can be a “live” mode, and a “training” mode. In a “live” mode, the SIRS 120 can perform any action instructed by the security analysts 130 (at block 740) on the respective OITSs 150, whereas in a “training” mode, the SIRS 120 can avoid performing the actions instructed by the security analysts 130 (thereby not affecting the OITSs 150) (block 750).

It is to be noted that, having the option of operating the SIRS 120 in a “training” mode, that does not have an effect on the OITSs 150, can enable a more seamless training of the security analysts 130. The security analysts 130 can perform as if they are dealing with a real cyber-attack, instead of a training exercise, while being unaware of the fact that their instructions (provided at block 740) are not performed on the OITSs 150. This can result in a very realistic training exercise, where the security analysts are unaware of the fact that they are participating in a training exercise. However, for this purpose, the SIRS 120 is required to enable such “training” mode.

In some cases, the SIRS 120 can be configured to perform the actions instructed by the security analysts 130 (at block 740) on one or more of the TRITS 160. In such cases, the SIRS 120 can be configured to perform any action instructed by the security analysts 130 on one or more corresponding TRITS 160 (to which the actions relate). This enables a more realistic training, in which the outcomes of the actions taken by the security analysts can be assessed, without jeopardizing the OITSs 150.

As indicated herein, the TRITS 160 can be copies of one or more corresponding OITSs 150 running in a real or virtual isolated environment can be isolated from the OITSs 150 environment, so that the TRITS 160 have no access to the OITSs 150 and vice versa. In such cases, the security analysts 130 can have access to one or more of the TRITS 160, via a single-sided connection (e.g. a one-way remote desktop connection session, enabling the security analyst 130 to view the screen of one or more of the TRITS 160, and to control the Input/output (10) devices of one or more of the TRITS 160). In other cases, the TRITS 160 can be installed on the same environment of the OITSs 150, and optionally also at least partially on the same hardware (e.g. servers).

It is to be noted that the TRITS 160 can be set-up (optionally by the management server 170) according to the training exercise performed, so that it can include copies of those OITSs that are affected by the training exercise, and optionally not include copies of other OITSs not affected by the training exercise.

As further detailed herein, the TRITS 160 can be utilized for enabling a security analyst 130 to investigate a simulated cyber-attack, and/or evidence thereof, optionally on an environment other than the OITSs 150 environment. This enables the security analyst 130 to perform various actions that affect one or more of the TRITS 160, optionally without affecting the OITSs 150 (e.g. in those cases where the TRITS 160 are installed on an environment isolated from the OITSs 150 environment). For this purpose, one or more attack simulations can be executed on one or more of the TRITS 160 for enabling a security analyst 130 to train on an attacked environment simulation, optionally separate from the OITSs 150. Alternatively, or additionally, one or more of the TRITS 160 can be configured to contain evidence indicative of the cyber-attack, also referred to herein as “attack evidence”. This can enable training the security analyst 130 on analysis of cyber-attacks and/or on responding to such cyber-attacks, without jeopardizing the OITSs 150. In some cases, the attack evidence can be generated by performing the attack on the at least one of the TRITS 160.

It is to be noted that in some cases, the SIRS 120 can be further configured to monitor (e.g. utilizing the response monitoring module 250) the responses of the security analysts 130 to the alerts raised by the SIRS 120 during a training exercise, or during a real cyber-attack, and collect information relating thereto. The information can include which instructions were received from the security analysts 130 (at block 740), a timestamp of each instruction provided by each security analysts 130 that provided one or more instructions, etc. Such information can be used for evaluating the security analysts 130 performance during a training exercise, or during a real cyber-attack, and for grading such performance, as further detailed herein, inter alia with reference to FIG. 8.

It is to be noted that, with reference to FIG. 7, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

FIG. 8 is a flowchart illustrating one example of a sequence of operations carried out for grading a security analyst training exercise, in accordance with the presently disclosed subject matter.

According to some examples of the presently disclosed subject matter, assessment system 140 can be configure to perform a grade calculation process 800, e.g. utilizing the grade calculator module 450.

For this purpose, the assessment system 140 can be configured to provide one or more of the security analysts 130 with one or more questions relating to responses of the respective security analyst to one or more cyber-attacks (block 810). The questions can be comprised in a form to be filled by the security analysts 130.

In some cases, the questions can be provided by a user such as the Security Operation Center (SOC) manager of the organization, optionally through a user interface of the assessment system 140 (that can optionally utilize form designer module 440 for this purpose). In some cases, the questions can be multiple choice and/or multiple selection questions. The user can also provide the assessment system 140 with expected answers to the questions provided thereby, to be used for grading a security analyst performance during a training exercise, as further detailed herein.

The assessment system 140 can receive answers, from each of the security analysts 130, to the questions provided to the respective security analysts 130 (block 820). In some cases, the assessment system 140 can further associate each received answer with a timestamp indicative of the time at which the answer was received.

The assessment system 140 can be further configured to calculate a grade for each security analyst 130 based at least on comparison of the answers provided by the respective security analyst 130 and the expected answers provided by the user. In some cases, the grade can be calculated also based on the timestamp. For example, the grade can be calculated utilizing the timestamps so that the faster the security analyst 130 performed the expected actions—the higher the grade is (optionally assuming that the answer is correct). Another example is that the security analyst 130 can be required to perform the action within a certain time (e.g. within five seconds, within thirty seconds, within one minute, within five minutes, within half an hour, etc.) in order to get a score associated with the specific expected action (assuming that a given expected action needs to be completed within ten seconds, the security analyst 130 can receive a score associated with this action if he performs the given expected action within ten seconds), and the timestamp can be used to determine if the security analyst 130 performed the given expected action on time.

In some cases, additionally or alternatively, the assessment system 140 can be configured to obtain information of actions performed by one or more of the security analysts 130 on the SIRS 120 and/or on one or more of the TRITS 160, and the grade can be calculated based on comparison of such actions with expected actions provided by a user authorized to determine such expected actions for the organization (e.g. a SOC manager of the organization). In some cases, the assessment system 140 can be configured to associate each action made by each security analyst 130 with a respective timestamp, and in such cases, the grade can be further calculated based on the timestamps. For example, the grade can be calculated utilizing the timestamps so that the faster the security analyst 130 performed the expected actions—the higher the grade is (optionally assuming that the action is the expected action as defined by the user). Another example is that the security analyst 130 can be required to perform the action within a certain time (e.g. within five seconds, within thirty seconds, within one minute, within five minutes, within half an hour, etc.) in order to get a score associated with the specific expected action (assuming that a given expected action needs to be completed within ten seconds, the security analyst 130 can receive a score associated with this action if he performs the given expected action within ten seconds), and the timestamp can be used to determine if the security analyst 130 performed the given expected action on time.

In some cases, additionally or alternatively, the assessment system 140 can be configured to obtain information of instructions provided by one or more of the security analysts 130 to the SIRS 120, and optionally timestamps indicative of the time such instructions were received. In such cases, the assessment system 140 can be configured to calculate the grade for each security analyst 130 based at least on comparison of the instructions provided by the respective security analyst 130 and the expected instructions provided by a user authorized to determine such expected actions for the organization (e.g. a SOC manager of the organization). In some cases, the grade can be calculated also based on the timestamp. For example, the grade can be calculated utilizing the timestamps so that the faster the security analyst 130 provided the expected instructions—the higher the grade is (optionally assuming that the instruction is the expected instruction as defined by the user). Another example is that the security analyst 130 can be required to provide the instruction within a certain time (e.g. within five seconds, within thirty seconds, within one minute, within five minutes, within half an hour, etc.) in order to get a score associated with the specific expected instruction (assuming that a given expected instruction needs to be provided within ten seconds, the security analyst 130 can receive a score associated with this instruction if he provided the given expected instruction within ten seconds), and the timestamp can be used to determine if the security analyst 130 provided the given expected instruction on time.

It is to be noted that these are mere examples of calculation of a grade for the security analysts 130, and grades can be calculated in additional and/or other manners, based on the above disclosed parameters and/or other parameters.

It is to be further noted that, with reference to FIG. 8, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system comprising a log generator, the log generator comprising a processor, the processor configured to:
generate, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and
provide the fictitious log files to the OLMS, thereby causing the OLMS to analyze the fictitious log, files, identify the evidence, and generate one or more alerts of the attacks.

2-5. (canceled)

6. The system of claim 1, wherein the processor is further configured to receive information identifying each OITS of the OITSs for which the fictitious log files are generated, the information including at least a type and a current version of the corresponding CATS, and wherein the fictitious log files are generated based on the received information.

7-8. (canceled)

9. The system of claim 1, wherein the alerts are provided to one or more security analysts of the organization for training purposes.

10-12. (canceled)

13. The system of claim 1, wherein the provide includes placing the fictitious log files in a first location monitored by the OLMS or in a second location accessible by a connector of the OLMS, the connector configured to collect and parse the fictitious log files of a given OITS of the OITSs.

14. (canceled)

15. The system of claim 9, further comprising one or more TRaining IT Systems (TRITSs), wherein (a) each TRITS is a copy of a corresponding OITS of the OITSs, and (b) at least one of the TRITS comprises attack evidence indicative of the attack, thereby enabling the security analysts to investigate the attack evidence.

16. The system of claim 15, further comprising an assessment system configured to calculate a grade for at least one of the security analysts, based on one or more actions performed on the TRITS by the security analyst and on expected actions defined by a Security Operation Center (SOC) manager of the organization.

17. The system of claim 16, wherein the assessment system is further configured to monitor respective timestamps of the actions made by each security analyst of the security analysts, and wherein the grade is further calculated based on the timestamps.

18. (canceled)

19. The system of claim 15, wherein the TRITSs are installed on an isolated environment, isolated from the OITSs environment, and wherein the TRITS can be accessed by the security analysts through a one directional connection.

20. (canceled)

21. The system of claim 9, further comprising a Security Incident Response System (SIRS), the SIRS configured to:
receive the alerts from the OLMS;
provide the alerts to the security analysts;
provide, to the security analysts, one or more suggested actions in response to the alerts;
receive at least one instruction, from the security analysts, based on the suggested actions; and
preform the instruction on the OITS in a first mode of the SIRS, being a live mode, and not performing the instruction on the OITS in a second mode, being a training mode.

22. The system of claim 21, further comprising an assessment system configured to calculate a grade for at least one of the security analysts, based on the at least instruction and on expected instructions provided by a Security Operation Center (SOC) manager of the organization.

23-25. (canceled)

26. A method comprising:
generating, by a processor, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and
providing, by the processor, the fictitious log files to the OLMS, thereby causing the OLMS to analyze the fictitious log files, identify the evidence, and generate one or more alerts of the attacks.

27-30. (canceled)

31. The method of claim 26, further comprising receiving, by the processor, information identifying each OITS of the OITSs for which the fictitious log files are generated, the information including at least a type and a current version of the corresponding OITS, and wherein the fictitious log files are generated based on the received information.

32-33. (canceled)

34. The method of claim 26, wherein the alerts are provided to one or more security analysts of the organization for training purposes.

35-37. (canceled)

38. The method of claim 26, wherein the providing includes placing the fictitious log files in a first location monitored by the OLMS or in a second location accessible by a connector of the OLMS, the connector configured to collect and parse the fictitious log files of a given OITS of the OITSs.

39. (canceled)

40. The method of claim 34, further comprising providing one or more TRaining IT Systems (TRITSs), wherein (a) each TRITS is a copy of a corresponding OITS of the OITSs, and (b) at least one of the TRITS comprises attack evidence indicative of the attack, thereby enabling the security analysts to investigate the attack evidence.

41. The method of claim 40, further comprising providing an assessment system configured to calculate a grade for at least one of the security analysts, based on one or more actions performed on the TRITS by the security analyst and on expected actions defined by a Security Operation Center (SOC) manager of the organization.

42. The method of claim 41, wherein the assessment system is further configured to monitor respective timestamps of the actions made by each security analyst of the security analysts, and wherein the grade is further calculated based on the timestamps.

43-44. (canceled)

45. The method of claim 34, further comprising providing a Security Incident Response System (SIRS), the SIRS configured to:
receive the alerts from the OLMS;
provide the alerts to the security analysts;
provide, to the security analysts, one or more suggested actions in response to the alerts;
receive at least one instruction, from the security analysts, based on the suggested actions; and
preform the instruction on the OITS in a first mode of the SIRS, being a live mode, and not performing the instruction on the OITS in a second mode, being a training mode.

46. The method of claim 45, further comprising providing an assessment system configured to calculate a grade for at least one of the security analysts, based on the at least instruction and on expected instructions provided by a Security Operation Center (SOC) manager of the organization.

47-49. (canceled)

50. A non-transitory computer readable storage medium having computer readable program code embodied therewith, the computer readable program code, executable by at least one processor of a computer to perform a method comprising:
generating, for each attack training scenario of one or more attack training scenarios, one or more fictitious log files identifiable by an Operational Log Monitoring System (OLMS) of an organization as log files of one or more Operational Information Technology (IT) Systems (OITSs) of the organization, each fictitious log file comprising one or more log entries identifiable by the OLMS as evidence of an attack, on at least one OITS of the OITSs, wherein the attack is defined by the attack training scenario; and
providing the fictitious log files to the OLMS, thereby causing the OLMS to analyze the fictitious log files, identify the evidence, and generate one or more alerts of the attacks.
